(19) United States
(12) Patent Application Publication
(10) Pub. No.: US 2004/0230902 A1
(43) Pub. Date: Nov. 18, 2004

(54) Web-page processing method for reducing load of server

(76) Inventors: Jenda Jao, Taipei (TW); Scott Lee, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/814,446

(22) Filed: Mar. 31, 2004

(30) Foreign Application Priority Data
Apr. 4, 2003 (TW) 092107798

(51) Int. Cl. G06F 15/00; G06F 17/30

(52) U.S. Cl. 715/513

(57) ABSTRACT

A web-page processing method, at the data write-in stage, converts a web page into web-page data to be stored in a database in a specified format, and parses the web-page data to locate a portion of contents associated with the server-side command(s). Further, the storage information of said portion of contents in the database is recorded as index data. At the run-time stage, the portion of contents associated with the server-side command(s) is outputted to the server when the index data is referred to in response to a read command of the server. Then, the server-side command(s) is executed by the server and outputted to the browser of the client's side.

### FIELD OF THE INVENTION

The present invention relates to a web-page processing method, and more particularly to a web-page processing method for reducing load of the associated server.

### BACKGROUND OF THE INVENTION

Nowadays, Internet communication is prevailing and thus a variety of services and a number of commercial behaviors are conducted by means of the Internet technologies. Efforts have been being made to build a custom service platform on the Internet, which allows a large quantity of information to be exchanged thereon in a highly efficient manner.

Referring to FIG. 1, a typical client-server networking architecture is shown. According to the client-server networking architecture, a client's side 11 and a server's side 12 are interconnected via Internet 13. At the client's side 11, via a terminal machine 111 such as a personal computer or a mobile phone and the Internet 13, a user 110 can exchange data with the server 121 at the server's side 12.

Take a client-server networking architecture providing World Wide Web (WWW) service, where data are transmitted or exchanged between the client's side 11 and the server's side 12 in a Hyper Text Transfer Protocol (HTTP), for example. The server 121 has to process web pages stored in a database 122 and the terminal machine 111 should be installed with an interpreter, which is so-called as a browser 112 in order to interpret and execute the web pages.

In the early stage of WWW service, the web pages were written in markup languages compatible with standard generalized markup language (SGML), such as Hyper Text Markup language (HTML). Thus, such web pages could only be hyperlinked in an inactive form. With the increasing demand of interaction on Internet, active web pages become mainstream for web design works. In general, server-push means and client-pull means dominate the designing aim of active web pages, which will be described hereinafter.

The server-push means is implemented by having the server actively control, refresh or change the contents of the web pages. The web pages formed in the server-push manner involve server-side commands, also referred as tags, and client-side commands. The client-side commands can be directly executed by way of the browser. The server-side commands, e.g. the commands constructed by Server Side Includes (SSI), Command Gateway Interface (CGI), Active Server Pages (ASP) or Perl Hypertext Processor (PHP) technology, on the other hand, need to be processed by the server so as to reveal the web pages. In contrast, the client-pull means is implemented by having the browser actively refresh the web pages. The web pages formed client-pull means involve only client commands.

Referring to FIG. 2, an active web page 21 formed in the server-push manner is exemplified. In this example, the active web page 21 contains client-side commands, i.e. HTML commands, and a server-side command I expressed as <I--#SSI CMD-->. The active web page 21 is converted into a specific entry of data in a common programmatic language such as C language before being stored into the database 122 (FIG. 1). The specific entry of data is stored in the database 122 in a byte-array form. Furthermore, the entry of data should be indexed from the filename of the web page 21 according to a file allocation table (FAT) utilized by the operating system of the server 121 (FIG. 1). The establishment of the file allocation table is well known in the art and need not be further described in detail herein.

Please refer again to FIG. 1. When the user 110 asserts a read request S1 to the server's side 12 via the browser 112 to read the web page 21 (FIG. 2), the server 121 will locate the data relevant to the web page 21 in the database 122 according to the filename information carried by the request S1 and the file allocation table. Then, the server 121 asserts a read command S2 to read the data having been located from the database 122. In response to a data output operation S3, the server 121 can obtain the web page 21. Before the web page 21 is transmitted to the client's side 11, a parsing operation of the web page 21 is performed by the server 121 to distinguish the SSI command I from the HTML commands. While the HTML commands are directly outputted to the browser 112 by a response operation S4, the SSI command I needs to be executed by the server 121 prior to response to the read request. For example, some server-inclusive information such as date, time or count of visitors, are inserted into the web page by executing the SSI command I first, and then outputted to the browser 112.

The operation of the above web-page processing method is summarized in brief in the flowchart of FIG. 3. Web pages are transformed into a plurality of entries of data in a common programmatic language format (Step 1). The data are stored in a database and the access paths to the data in the database are recorded in the FAT (Step 2). In response to a read request from a browser at the client's side to read a specific web page (Step 3), the server asserts a read command to locate the address of a specific entry of data relevant to the requested web page according to the FAT. Then, the specific entry of data at the located address is outputted to the server (Step 4). In response to the receipt of the data from the database (Step 5), the server parses the tags of data (Step 6) to see if the currently received data is directed to a server-side command (Step 7). If the data is a server-side command, it will be executed by the server and then the executing result is output to the browser (Step 8). On the other hand, if the currently received data is not a server-side command in Step 7, the received data contents will be directly outputted to the browser of the client's side (Step 10). Now back to Step 5, the end of the specific entry of data is determined when the flag representing the end of file (EOF) has been hoisted, and it means the processing of the requested web page has been completed.

Since the parsing operation is basically a string-matching task, the processing procedure is time-consuming. For example, the speed of a server for processing a web page by omitting from performing the parsing operation can be up to several times of that of the same server for processing the same web page by performing the parsing operation. As the data amount of the web page increases, the load of the server is getting heavier. On the other hand, if the computation ability of the processor of the server is not strong enough, the service efficiency of the server would be significantly lowered.

A conventional approach to the reduced load of the server upon processing a web page is to provide distinguishable filenames for the web pages requiring and not requiring the parsing operation, i.e. including and not including server-side command(s), respectively. For example, for the web pages containing no server-side command are ended with “.html” or “.htm” as usual. Differentially, the filenames of the web pages requiring the parsing operation are intentionally ended with “.phtml”, “.phtm” or “.html-ssi”. As such, only the web pages having the distinctive filename extensions like “.phtml”, “.phtm” or “.html-ssi” need the parsing operation. As for the web pages having the common filename extensions like “.html” or “.htm”, the parsing operation can be omitted so as to reduce the load of the server. In spite this approach did enhance the efficiency of the server to some extent, it is not good enough particularly when the working efficiency of the processor of the server is not as high as required.

### SUMMARY OF THE INVENTION

Therefore, the present invention provides a web-page processing method, in which the parsing operation performed by a server after receiving a read request from a browser at the client's side can be omitted, so as to reduce the load of the server.

A first aspect of the present invention relates to a web-page processing method, comprises steps of: parsing web-page data to locate a first portion of contents associated with a server-side command; recording storage information of the first portion of contents in a database as a first index data; and outputting the first portion of contents to a server when the first index data is referred to in response to a read command of the server.

Preferably, the parsing step further locates a second portion of contents associated with a client-side command, and the method further comprises steps of: recording storage information of the second portion of contents in the database as a second index data; and outputting the second portion of contents to the server when the second index data is referred to in response to the read command of the server.

The first portion of contents is a first command block including one or more continuous server-side commands, and the second portion of contents is a second command block including one or more continuous client-side commands.

Preferably, the first and second command blocks are immediately adjacent to each other.

In an embodiment, the method further comprises steps of: executing the first command block by the sever, and outputting the executing result to web-page request means; and outputting the second command block to the web-page request means without being executed by the server. The web-page request means, for example, is a browser of a client's side.

The client-side command, for example, is written in a Hyper Text Markup language (HTML).

In an embodiment, the first and second index data are stored in the database as an array or a linking list, and are referred to according to the filename of the processed web page and a file allocation table associated with an operating system of the server.

Preferably, the first and second index data include one or more items selected from a group consisting of a command-identifying code, starting address of the storage position, end address of the storage position and total length of the first portion of contents.

In an embodiment, the web-page data is converted from a web page written in a markup language compatible with a standard generalized markup language (SGML) and have a specified format of a common programmatic language.

For example, the server-side command is constructed by Server Side Includes (SSI), Command Gateway Interface (CGI), Active Server Pages (ASP) or Perl Hypertext Processor (PHP) technology.

According to a second aspect of the present invention, the web-page processing method comprises steps of: building an index file of a web page, wherein information of a first command block including one or more continuous server-side commands and a second command block including one or more continuous client-side commands are recorded; referring to the index file in response to a web-page read request; locating and outputting the first command block to a server according to information of the first command block recorded in the index file; and locating and outputting the second command block to the server according to information of the second command block recorded in the index file.

In an embodiment, the web-page processing method further comprises steps of: executing the first command block by the sever, and outputting the executing result to web-page request means; and outputting the second command block to the web-page request means without being executed by the server.

Preferably, the index file is referred to in response to the web-page read request according to the filename of the web page and a file allocation table associated with an operating system of the server.

A third aspect of the present invention relates to a web-page processing method, comprising steps of: referring to an index file which records therein respective storage information of server-side and client-side commands of a specific web page in a database in response to a read request from web-page requesting means; locating and outputting the server-side and the client-side commands to a server according to the storage information recorded in the index file, respectively; executing the server-side command by the server; and outputting the specific web page from the server to the web-page requesting means.

Preferably, the specific web page is parsed to distinguish a first command block including one or more continuous server-side commands from a second command block including one or more continuous client-side commands, and storage information of the first and second command blocks in the database are recorded in the index file.

In an embodiment, the specific web page outputted from the server to the web-page requesting means includes contents associated with the executing result of the server-side command and contents associated with the client-side command without being executed by the server.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating a typical client-server networking architecture;

FIG. 2 is a schematic diagram illustrating an active web page containing client-side and server-side commands;

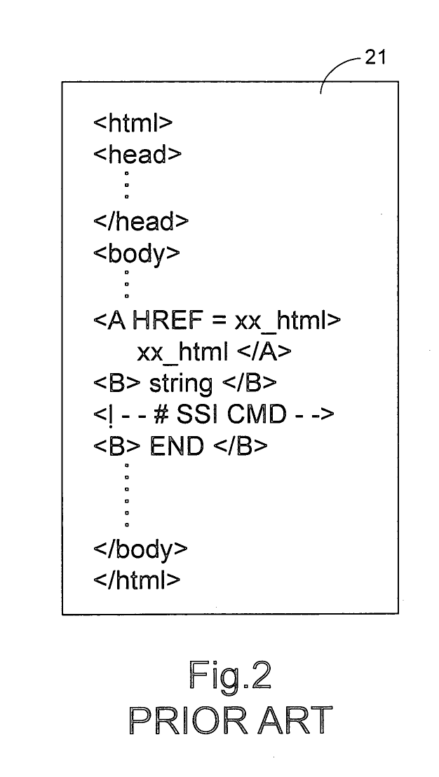

FIG. 3 is a flowchart of a conventional web-page processing method;

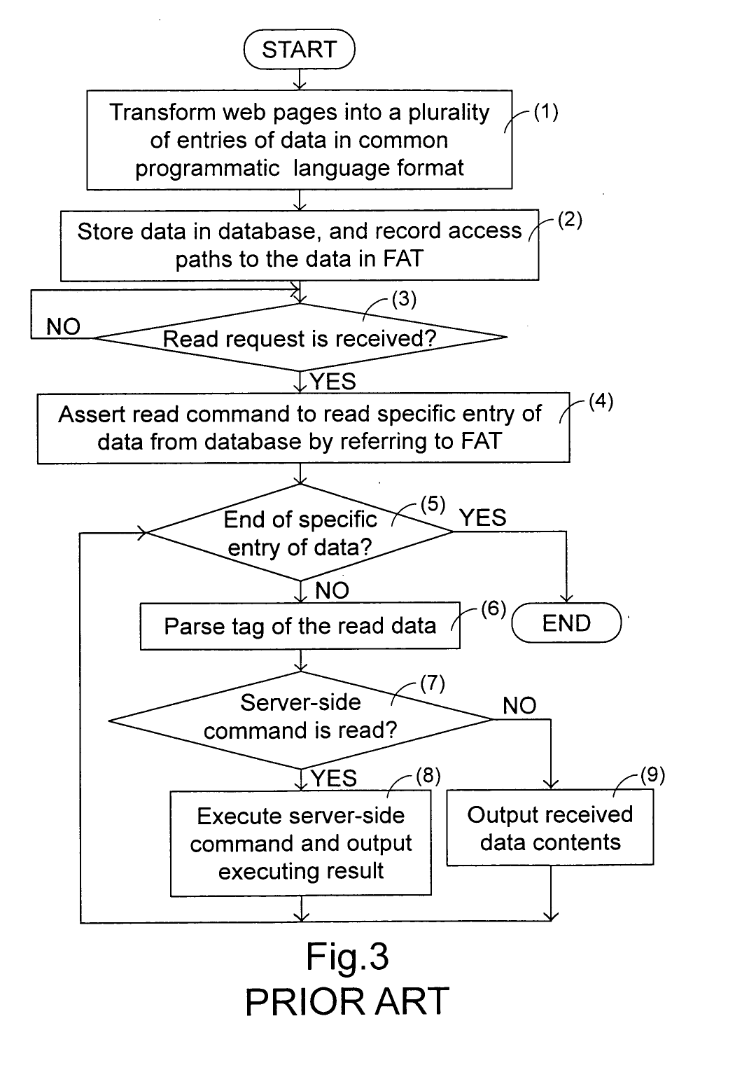

FIG. 4 is a schematic diagram illustrating the parsed result of the active web page of FIG. 2 according to an embodiment of the present invention; and

FIG. 5 is a flowchart of an exemplified web-page processing method according to the present invention.

### DETAILED DESCRIPTION OF THE PREFERRED EMBODIMENT

A web-page processing method according to a preferred embodiment of the present invention will be illustrated hereinafter. The load of the associated server can be reduced in the present method by eliminating the parsing operation conventionally performed after receiving a read request from a browser at the client's side.

Generally, the web pages are converted into a plurality of entries of data in a common programmatic language format such as C language format, and then stored in the database 122 in a byte-array form. Each of the web pages may optionally include one or more server-side commands and one or more client-side commands. The server-side commands can be constructed by Server Side Includes (SSI), Command Gateway Interface (CGI), Active Server Pages (ASP) or Perl Hypertext Processor (PHP) technology, and need to be processed by the server so as to reveal the web page. The client-side commands are typically written in a Hyper Text Markup language (HTML). According to the present invention, index files recording therein a plurality of index data relating to specified information of web pages are additionally built and stored in the database where the contents of the web pages are stored.

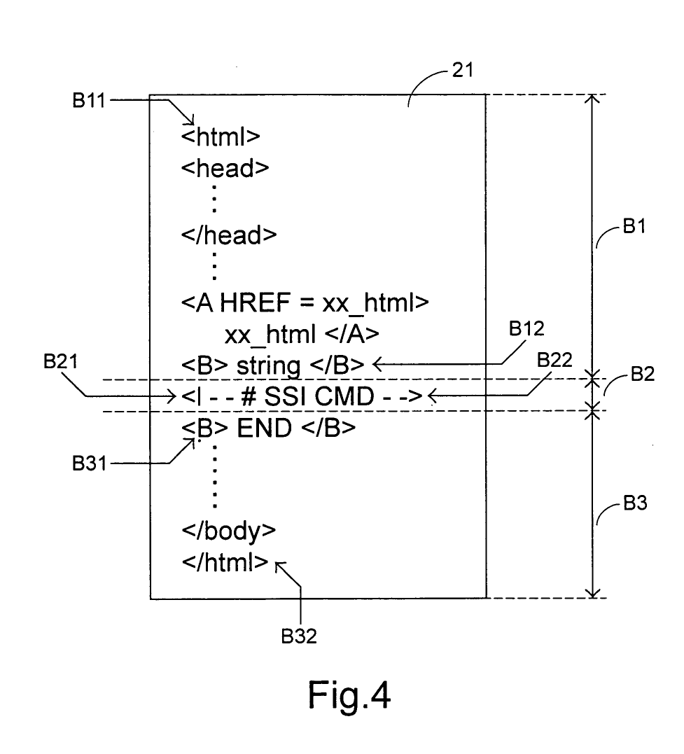

In order to build the index files, each of the web pages is parsed to locate the portion associated with the server-side command(s) and the portion associated with the client-side command(s). The active web page as illustrated in FIG. 4 is used herein as an example for illustration. Referring to FIG. 4, the active web page 21 containing the client-side commands (i.e. HTML commands) and the server-side command I (e.g. expressed as<I--#SSI CMD-->) is parsed to distinguish the server-side command from the client-side commands and locate three adjacent command blocks B1, B2 and B3. The command block B1 consists of a plurality of continuous client-side commands starting from B11 and ending at B12. The command block B2 consists of a single server-side command, i.e. the starting and ending positions B21 and B22 are the same. The command block B3 consists of a plurality of client-side commands starting from B31 and ending at B32. A variety of information associated with the command blocks, including the their storage addresses in the database, can be recorded as corresponding index data in the index file so that the command blocks can be extracted from the database when required by referring to the index file. The index data, for example, include command-identifying codes (e.g. for identifying the command blocks B1, B2 and B3), starting addresses of the command blocks (e.g. corresponding to B11, B21 and B31), end addresses of the command blocks (e.g. corresponding to B12, B22 and B32) and total length of the command blocks. Since the storage positions of the command blocks in the database can be realized by referred to the index data, the data relevant to the requested web page can be outputted in response to the read request from the browser of the client's side without any real-time parsing operation.

Preferably, the index data are stored in the database in an array or a linking list format, and are referred to according to the filename of the requested web page and the file allocation table (FAT) associated with an operating system of the server 121.

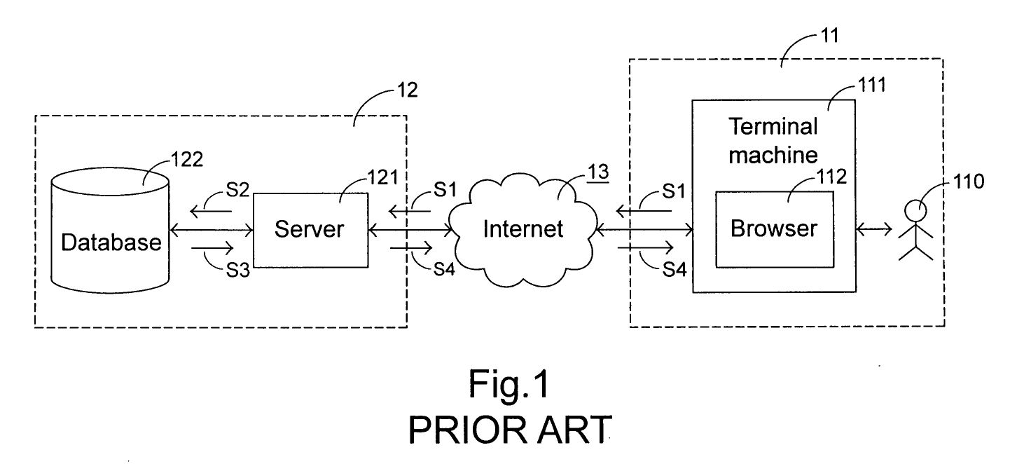

When the user 110 asserts a read request S1 to the server's side 12 via the browser 112 to read a specific web page (with reference to FIG. 1), the server 121 asserts a read command S2 to locate the index file in the database 122 according to the filename information carried by the request S1 and the file allocation table. According to the index data in the index file, the storage positions of the command blocks in the database 122 are realized. Then, the server 121 asserts another read command to read the data relevant to the requested web page (hereinafter referred to as web-page data) from the database 122. In response to the read command, the database 122 outputs the web-page data to the server in blocks by a data output operation S3. Herein, that the web-page data are outputted in blocks means that the data in the same commend block can be continuously outputted or preliminarily executed by the server because the web-page data have been previously parsed to isolate the server-side command block. For example, the client-side commands in the command block B1 of the web-page data of FIG. 4 can be outputted from the server 121 to the browser 112 by a response operation S4 quickly and continuously. Once the server-side command block B2 is entered, the server-side command in the server-side command block B2 is automatically interpreted and executed by the server 121 first, and then the executing result is outputted from the server 121 to the browser 112 by a response operation. After the command block B2 is processed and the client-side command block B3 is entered, the client-side command block B3 can be outputted from the server 121 to the browser 112 quickly and continuously again. By this way, the requested web page can be efficiently outputted to the browser 112 of the client's side 11.

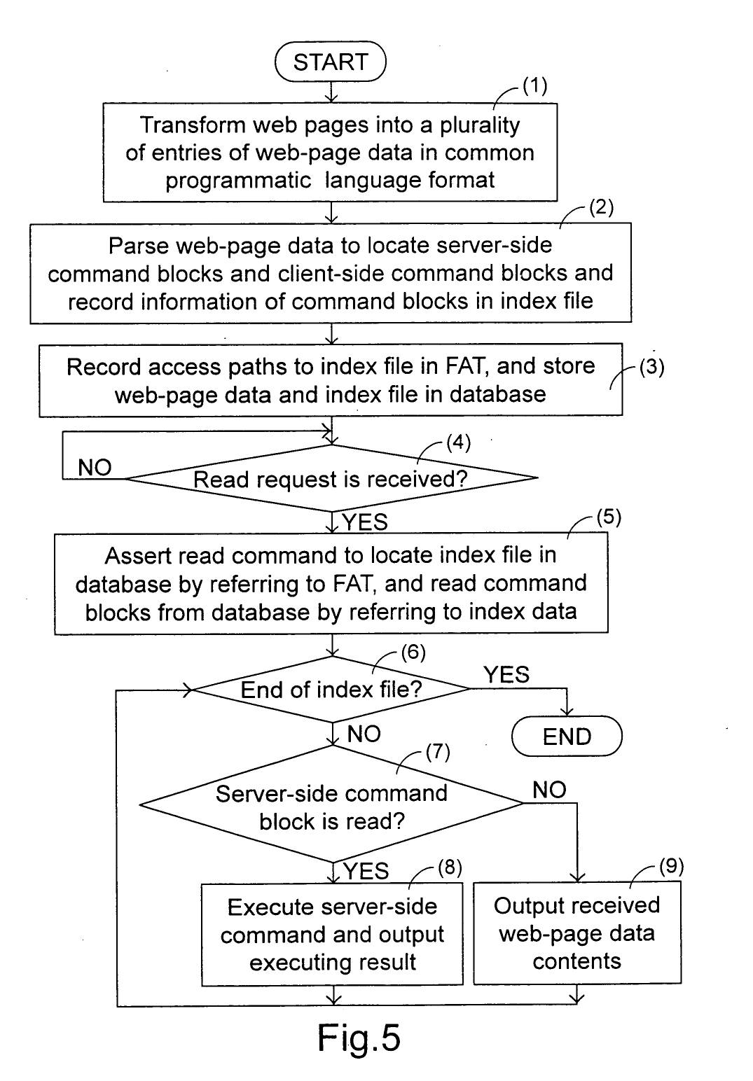

The embodiment of the web-page processing method described above is summarized in brief in the flowchart of FIG. 5. In the data write-in stage, web pages are converted into web-page data in a common programmatic language format (Step 1). Each of the web-page data, e.g. tags, is parsed to locate the server-side and client-side command blocks, respectively, and the information of the command blocks are recorded as index data in an index file. Of course, it is possible to perform the parsing operation only for the web-page data including therein server-side command(s). The access path to the index file is recorded in the file allocation table (FAT), and the web-page data and index file are stored in a database (Step 3). In response to a read request from a browser at the client's side to read a specific web page (Step 4), a read command is asserted by the server to locate the index data by referring to FAT. According to the index data, the storage position of the index file relevant to the requested web page in the database is realized. Therefore, the command blocks can be read out from the database by referring to the corresponding index data in the index file (Step 5). In response to the receipt of the index data from the database (Step 6), the command blocks are outputted from the database to the server accordingly. If what are currently received by the server are the contents of the web-page data associated with a client-side command block (Step 7), the commands in the same client-side command block are quickly and continuously outputted from the server to the browser (Step 9). On the other hand, if it is the contents associated with the server-side command block received (Step 7), the server-side command will be executed first by the server, and then outputted to the browser (Step 8). When the flag representing the end of file (EOF) has been hoisted in Step 6, it means the processing of the requested web page has been completed.

Since the parsing operation is previously performed in the data write-in stage other than run-time stage, the web-page processing method of the present invention is capable of reducing load of the server.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A web-page processing method, comprising steps of:
parsing web-page data to locate a first portion of contents associated with a server-side command;
recording storage information of said first portion of contents in a database as a first index data; and
outputting said first portion of contents to a server when said first index data is referred to in response to a read command of said server.

2. The method according to claim 1 wherein said parsing step further locates a second portion of contents associated with a client-side command, and the method further comprises steps of:
recording storage information of said second portion of contents in said database as a second index data; and
outputting said second portion of contents to said server when said second index data is referred to in response to said read command of said server.

3. The method according to claim 2 wherein said first portion of contents is a first command block including one or more continuous server-side commands, and said second portion of contents is a second command block including one or more continuous client-side commands.

4. The method according to claim 3 wherein said first and second command blocks are immediately adjacent to each other.

5. The method according to claim 3 further comprising steps of:
executing said first command block by said sever, and outputting the executing result to web-page request means; and
outputting said second command block to said web-page request means without being executed by said server.

6. The method according to claim 5 wherein said web-page request means is a browser of a client's side.

7. The method according to claim 2 wherein said client-side command is written in a Hyper Text Markup language (HTML).

8. The method according to claim 2 wherein said first and second index data are stored in said database as an array or a linking list, and are referred to according to the filename of the processed web page and a file allocation table associated with an operating system of said server.

9. The method according to claim 2 wherein said first and second index data include one or more items selected from a group consisting of a command-identifying code, starting address of said storage position, end address of said storage position and total length of said first portion of contents.

10. The method according to claim 1 wherein said web-page data is converted from a web page written in a markup language compatible with a standard generalized markup language (SGML) and have a specified format of a common programmatic language.

11. The method according to claim 1 wherein said server-side command is constructed by Server Side Includes (SSI), Command Gateway Interface (CGI), Active Server Pages (ASP) or Perl Hypertext Processor (PHP) technology.

12. A web-page processing method, comprising steps of:
building an index file of a web page, wherein information of a first command block including one or more continuous server-side commands and a second command block including one or more continuous client-side commands are recorded;
referring to said index file in response to a web-page read request;
locating and outputting said first command block to a server according to information of said first command block recorded in said index file; and
locating and outputting said second command block to said server according to information of said second command block recorded in said index file.

13. The method according to claim 12 further comprising steps of:
executing said first command block by said sever, and outputting the executing result to web-page request means; and
outputting said second command block to said web-page request means without being executed by said server.

14. The method according to claim 12 wherein said client-side command is written in a Hyper Text Markup language (HTML).

15. The method according to claim 12 wherein contents of said web page are stored in a database in a common programmatic language format.

16. The method according to claim 15 wherein said information of said first command block and said second command block include one or more items selected from a group consisting of a command-identifying code, starting address of said storage position, end address of said storage position and total length of said first portion of contents.

17. The method according to claim 16 wherein said index file is stored in said database in an array or a linking list format.

18. The method according to claim 12 wherein said index file is referred to in response to said web-page read request according to the filename of said web page and a file allocation table associated with an operating system of said server.

19. A web-page processing method, comprising steps of:
referring to an index file which records therein respective storage information of server-side and client-side commands of a specific web page in a database in response to a read request from web-page requesting means;
locating and outputting said server-side and said client-side commands to a server according to said storage information recorded in said index file, respectively;
executing said server-side command by said server; and
outputting said specific web page from said server to said web-page requesting means.

20. The method according to claim 19 wherein said specific web page is parsed to distinguish a first command block including one or more continuous server-side commands from a second command block including one or more continuous client-side commands, and storage information of said first and second command blocks in said database are recorded in said index file.

21. The method according to claim 20 wherein said specific web page outputted from said server to said web-page requesting means includes contents associated with the executing result of said server-side command and contents associated with the client-side command without being executed by said server.
